(19) United States
(12) Patent Application Publication
(10) Pub. No.: US 2009/0064160 A1
(43) Pub. Date: Mar. 5, 2009

(54) Transparent lazy maintenance of indexes and materialized views

(75) Inventors: Per-Ake Larson, Redmond, WA (US); Jingren Zhou, Bellevue, WA (US); Hicham G. Elmongui, West Lafayette, IN (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/897,770

(22) Filed: Aug. 31, 2007

(51) Int. Cl. G06F 9/46

(52) U.S. Cl. 718/104

(57) ABSTRACT

Described herein is a materialized view or index maintenance system that includes a task generator component that receives an indication that an update transaction has committed against a base table in a database system. The task generator component, in response to the update transaction being received, generates a maintenance task for one or more of a materialized view or an index that is affected by the update transaction. A maintenance component transparently performs the maintenance task when a workload of a CPU in the database system is below a threshold or when an indication is received that a query that uses the one or more of the materialized view or the index has been received.

### BACKGROUND

Continued advances in technology in the field of computing have enabled massive quantities of data to be generated by computing devices and retained in data repositories. For instance, modern databases may include several terabytes of data, the majority of which is retained in large base tables. Despite an ever-increasing amount of computational power, however, executing certain queries against these base tables may require a significant amount of time. Accordingly, various tools have been developed to aid in reducing time required to execute a query against a database. Materialized views are one of these tools.

Materialized views transparently pre-compute joins and aggregations and, when applicable, may reduce query execution time by orders of magnitude when compared with executing a query against base tables. To effectively use a materialized view, however, the view needs to be kept current. In other words, an update to a base table may affect contents of a materialized view. If a materialized view is not maintained (e.g., kept current), use of the materialized view when executing the query will result in the return of obsolete results.

Many conventional database systems immediately maintain materialized views when base tables are updated. More specifically, affected views are maintained as part of an update statement or update transaction. Using this approach, the costs of maintaining materialized views are entirely borne by the updates, while queries using materialized views are unaffected. Such maintenance costs can be quite high, resulting in poor response time for the updates.

Another conventional approach to maintain materialized views is to defer maintenance until receipt of an external, user-initiated trigger. Using this approach, updates occur more quickly; however, the risk of executing a query against an obsolete materialized view exists. To ensure that a materialized view is not obsolete, a user must have knowledge of which materialized views a query will use and whether the materialized views are currently up to date. Accordingly, then, using this approach, materialized views may not be transparent to the user.

Indexes can be viewed as simple materialized views in that each index references only a single base table. Like materialized views, conventional database systems immediately maintain indexes when base tables are updated.

### SUMMARY

Briefly described, various technologies are described herein that pertain to maintaining materialized views and/or indexes in a database system. Materialized views/indexes in database systems reference base tables that may be subject to update transactions. When a base table upon which a materialized view/index depends is updated, a maintenance task can be generated, wherein performance of the maintenance task updates at least a portion of the materialized view/index. The maintenance task may be placed in a pending task list until, for example, a workload of a CPU in the database system is below a pre-defined threshold. When the workload of the CPU is below the threshold, the maintenance task can be performed (e.g., one or more low priority threads can be executed to perform the maintenance task).

In some instances, however, a query that uses the materialized view/index may be received prior to the maintenance task being performed or during performance of the maintenance task. If the query is received prior to the maintenance task being initiated, the maintenance task can be performed and the query can execute after the materialized view/index has been maintained. If the query is received during performance of the maintenance task, the query can be scheduled to execute after the maintenance task has been completed.

To increase efficiency with respect to performing maintenance tasks, a plurality of maintenance tasks may be combined to create a single maintenance task. For instance, a plurality of maintenance tasks may be created due to a sequence of update transactions against a base table. The changes from this sequence of update transactions may be concatenated to create a single, larger maintenance task covering the sequence of updates. It is to be understood, however, that other techniques may be used to increase efficiency with respect to performing maintenance tasks, such as optimization of maintenance tasks, optimization of maintenance tasks combined with concatenation, etc.

When a plurality of maintenance tasks that are pending and are not combinable or otherwise not combined exist, the maintenance tasks may be prioritized so that maintenance tasks deemed most urgent are performed earlier while those that are deemed less urgent are performed later. For instance, if a query that uses a materialized view is expected to be received, a pending maintenance task for the materialized view may be assigned a high priority.

Those skilled in the art will appreciate still other aspects of the present application upon reading and understanding the attached figures and description.

### BRIEF DESCRIPTION OF THE DRAWINGS

FIG. 1 is a functional block diagram of an example system that facilitates performance of a maintenance task for a materialized view and/or index.

FIG. 2 is a functional block diagram of an example system that generates maintenance tasks.

FIG. 3 is a functional block diagram of an example system that performs maintenance tasks for materialized views and/or indexes.

FIG. 4 is a functional block diagram of an example system that performs maintenance tasks for materialized views and/or indexes.

FIG. 5 is a flow diagram that illustrates an example methodology for performing a maintenance task with respect to a materialized view and/or index.

FIG. 6 is a flow diagram that illustrates an example methodology for combining maintenance tasks.

FIG. 7 is a flow diagram that illustrates an example methodology for condensing delta streams.

FIG. 8 illustrates a series of example timing diagrams for performing maintenance tasks on a materialized view and/or index.

FIG. 9 is an example database system.

### DETAILED DESCRIPTION

Various technologies pertaining to maintenance of materialized views will now be described with reference to the drawings, where like reference numerals represent like elements throughout. In addition, several functional block diagrams of example systems are illustrated and described herein for purposes of explanation; however, it is to be understood that functionality that is described as being carried out by certain system components may be performed by multiple threads of execution. Similarly, for instance, a single thread of execution may be configured to perform functionality that is described as being carried out by multiple components.

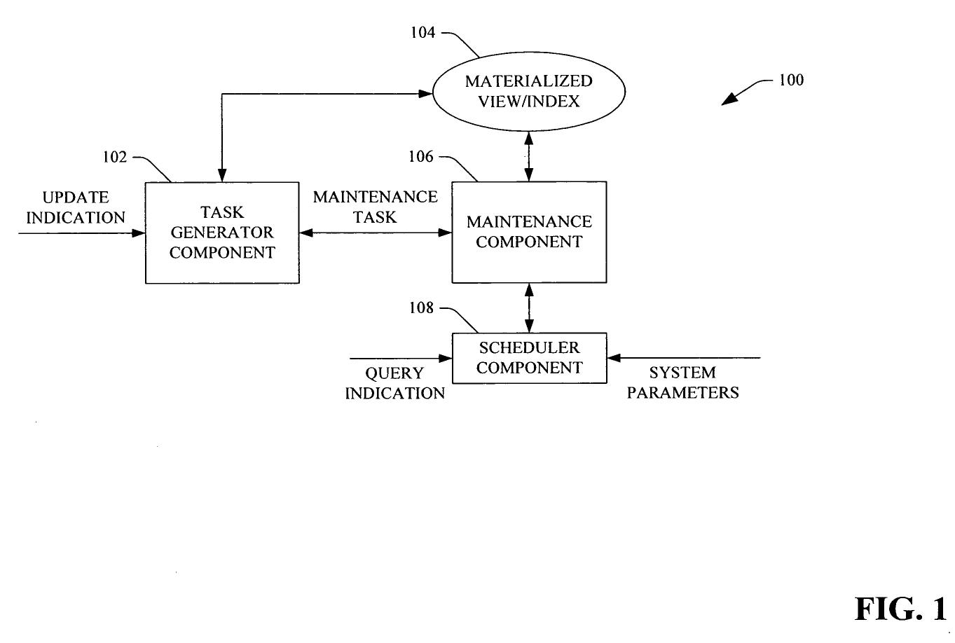

With reference to FIG. 1, an example materialized view and/or index maintenance system 100 is illustrated. The system 100 includes a task generator component 102 that receives an indication that a base table in a database system has been updated. The task generator 102 analyzes the update and determines that a materialized view/index 104 is affected by the update. That task generator 102 may employ various techniques in connection with determining that the materialized view/index is affected by an update. For example, the materialized view/index 104 may depend upon a row that has been updated in the base table. Upon receiving the indication that the base table has been updated and determining that the update affects the materialized view/index 104, the task generator component 102 can generate a maintenance task for the materialized view/index 104.

A maintenance component 106 receives the maintenance task and can automatically complete such task with respect to the materialized view/index 104 according to a schedule generated by a scheduler component 108. For instance, the scheduler component 108 may analyze system parameters and schedule completion of the maintenance task by the maintenance component 106, for example, when a workload of a CPU in the database system is below a pre-defined threshold (e.g., when the CPU is executing at a certain percentage of maximum capacity). In another example, the scheduler component 108 can analyze priorities of currently executing threads and schedule completion of the maintenance task based at least in part upon the analyzed priorities. Of course, other manners determining when to schedule maintenance of a materialized view without adversely affecting performance of a database system are contemplated and are intended to fall within the scope of the hereto-appended claims.

Furthermore, the scheduler component 108 can receive an indication that a query has been issued that uses the materialized view/index 104. In such an instance, the scheduler component 108 may schedule the maintenance component 106 to perform the maintenance task prior to the query using the materialized view/index 104 so that the view/index is not obsolete when used by the query. The maintenance component 106 completes the maintenance task transparently to an issuer of the query, such that the issuer of the query need not have knowledge of materialized views used by the query.

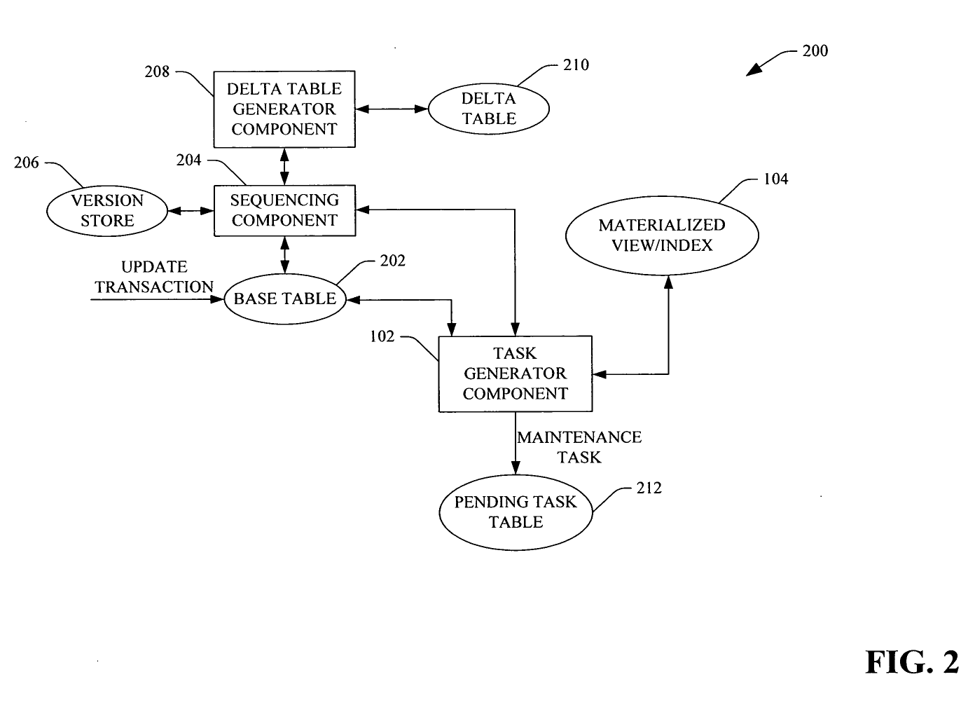

Now referring to FIG. 2, an example system 200 that facilitates generating a maintenance task is illustrated. The system 200 includes a database system base table 202 that is subject to an update transaction. The task generator component 102 receives an indication that the base table 202 has been subject to the update transaction and determines that the update transaction affects the materialized view/index 104.

A sequencing component 204 receives the update transaction and updates a version store 206 with information relating to the transaction. Previous versions of the base table 202 and other base tables in the database system can be read through use of the version store 206. The sequencing component 204 can assign unique transaction sequence number (TSXN) when the update transaction begins and can assign a commit sequence number (CSN) when the update transaction commits. In an example, the TSXN and CSN may be monotonically increased. Additionally, each statement within the update transaction is assigned a unique statement number (STMTSN). Each record in the version store 206, then, includes version information, such as which transaction (TXSN) and which statement (STMTSN) created the version of the record. Therefore, if given a TXSN and a STMTSN, the version store 206 can return record versions as of either a beginning or an end of the update transaction statement.

The system 200 additionally includes a delta table generator component 208 that can generate a delta table 210, which generally may be used to save changes made to the base table 202 (e.g., changes made by the update transaction). With more specificity, execution of an insert, delete, or update statement against the base table 202 can produce a delta stream, which may then be transformed by the delta table generator component 208 into a split delta stream with an additional column. Each delta row in the split delta stream can encode what change was made to a uniquely identified row of the base table 202. The additional column can indicate if the delta row represents an insert, delete, or update of a row. In an example, in a split delta stream, an update may be represented by two delta rows, one including old values and indicated by a delete indicator in the additional column and one including the new values and indicated by an insert indicator in the additional column. The delta table 210 can be an accumulation of split delta streams for the base table 202. Additionally, the delta table generator component 208 can append two additional columns to each row of the delta table 210, wherein the two additional columns may include the TXSN and the STMTSN that indicate which transaction and statement produced a delta row. Information for the two additional columns may be received by the delta table generator 208 from the sequencing component 204.

When the update transaction commits with respect to the base table 202 (and possibly other base tables), the task generator component 102 can generate a maintenance task for each affected materialized view and can further index and store the maintenance task in a pending task table 212, which may include a plurality of maintenance tasks. A maintenance task generated by the task generator component 102 may specify which materialized view/index is affected by an update transaction (e.g., materialized view/index 104), one or more base tables that have been updated (e.g., base table 202), the TXSN and the CSN of the update transaction, the STMTSN of the statement of the update transaction that first affects the materialized view/index, the current status of the maintenance task (e.g., pending, in progress, or completed), and/or other suitable information. As alluded to above and as will be described in greater detail below, the maintenance component 106 (FIG. 1) can access the pending task table 212 and perform a maintenance task therein per a schedule generated by the scheduler component 108. The maintenance component 106 may use the information specified by the maintenance task to properly access the version store 206 and the delta table 210 to maintain the materialized view/index 104. In an instance that an index is to be maintained, the version store 206 may not be required because an index is defined on a single base table. In the following description, materialized views are used to describe view/index maintenance. Maintaining an index can be treated as a special case.

In an example, an update transaction T with transaction sequence number denoted T_{TXSN} can be executed against a portion of a base table referenced by the materialized view 104, wherein the transaction T includes multiple statements. For instance, the third statement of T may be an insert statement that inserts rows AR into a base table R and the materialized view 104 may reference base table R and another base table S. If the materialized view 104 were maintained immediately after the aforementioned insert statement, the maintenance component 106 (FIG. 1) would obtain a version of S from the version store 206 that includes all updates that committed before the transaction T started and all updates caused by T prior to the insert statement. Therefore, a maintenance task generated by the task generator component 102 would include TXSN=T_{TXSN} and STMTSN=3. If the earlier statements in the update transaction T did not update table S, STMTSN may be optional because the version of S seen by the insert statement is the same as of the beginning of the transaction. In this case, the maintenance task generated by the task generator component 102 includes changes from all update statements in the update transaction. This type of maintenance task may be referred to as a “full maintenance task.”

In a variation of the above example, the fourth statement of T may reference the materialized view 104. Accordingly, the materialized view 104 should be maintained up to the point of the fourth statement, including the changes made by the third statement (the insert statement) that inserts ΔR. Such maintenance becomes permanent once the transaction Tcommits. Continuing with the example, the fifth statement of T may update table S (also referenced by the materialized view 104). The corresponding maintenance task generated by the task generator component 102 may include the TXSN=T_{TXSN} and STMTSN=5. In this case, the statement number informs the maintenance component 106 that all delta streams generated by statements prior to the fifth statement have already been applied to the materialized view 104 and only remaining delta streams from the update transaction need to be applied to complete maintenance of the materialized view/index 104. This type of maintenance task may be referred to as a “partial maintenance task.”

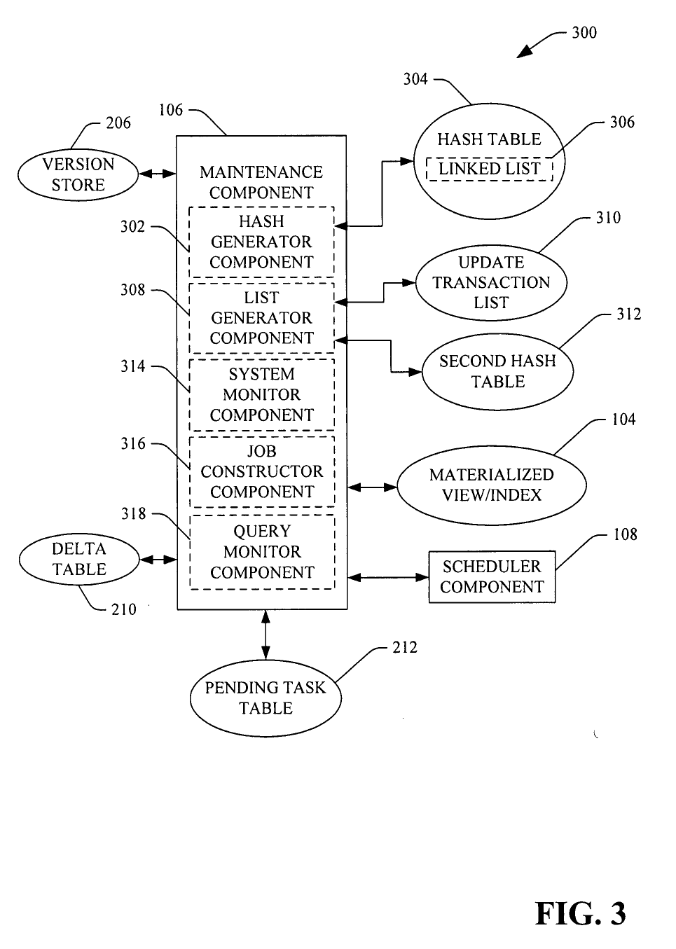

With reference now to FIG. 3, an example system 300 that performs materialized view and/or index maintenance is illustrated. The system 300 includes the maintenance component 106, which can perform a maintenance task on the materialized view/index 104 according to a schedule generated by the scheduler component 108. The maintenance component 106 can monitor active view maintenance tasks and can also determine which versions in the version store 206 and which delta streams in the delta table are needed to perform maintenance tasks in the pending task table 212.

To aid in monitoring pending maintenance tasks for the materialized view/index 104, the maintenance component 106 may optionally include a hash generator component 302 that can create a hash table 304 that may include an entry for each materialized view/index that has a maintenance task in the pending task table 212. Each entry in the hash table 304 may have a linked list 306 that, for example, includes the maintenance tasks of the view/index, wherein, for example, the list 306 can be sorted in an increasing order on commit sequence number.

To aid in monitoring versions in the version store 206 and delta streams in the delta table 210 that are needed to perform maintenance tasks in the pending task table 212, the maintenance component 106 may optionally include a list generator component 308 that can generate and maintain an update transaction list 310. The update transaction list 310 is a list of update transactions with pending view maintenance tasks. In addition, the list generator 308 may create a second hash table 312 and insert update transactions into such table to allow access to update transactions based upon CSN. Using the hash table 304, the update transaction list 310, and the second hash table 312, the maintenance component 106 can maintain versions in the version store 206 and delta streams in the delta table 210 needed for maintenance and can properly release obsolete versions and delete obsolete delta streams.

The system 300 may also include a system monitor component 314 that can monitor current operation parameters of the database system, such as, for instance, the current or expected workload of one or more CPUs in the database system. The system monitor component 314 can provide this information to the scheduler component 108, which can generate a schedule for at least a portion of a maintenance task in the pending task table 212. A job constructor component 316 can construct a maintenance job, and the scheduler 108 can schedule the maintenance job as a background maintenance job if the database system is detected as not being busy by the system monitor component 314. For instance, a maintenance job may be a single full or partial maintenance task or a combination of maintenance tasks in the pending task table 212. The job constructor component 316 can, for example, construct the maintenance job as a function of urgency of performing one or more maintenance tasks, expected workload of one or more CPUs in the database system over a period of time given consumption of CPU cycles expected to be required to complete a prospective maintenance job, etc. The maintenance component 106 may then execute the maintenance job according to the schedule generated by the scheduler component 108. As will be described in more detail below, the maintenance component 106 can access the version store 206 and the delta table 210 (and possibly other delta stores) in connection with executing the maintenance job. If several maintenance jobs are executed with respect to the materialized view/index 104, such jobs may be executed in the commit order of the originating update transactions.

In another example, prior to the scheduler component 108 scheduling a maintenance task in the pending task table 212 for the materialized view/index 104, a query monitor component 31 8 may discern that a query that uses the materialized view/index 104 has been issued. In more detail, the query monitor component 318 can inspect the query plan for the query to determine which materialized views/indexes it uses and, for each such materialized view/index, check as to whether the materialized views/indexes 104 have any pending maintenance tasks and whether the maintenance tasks originate from update transactions whose effects the query is supposed to see. If snapshot isolation is used, the query should see transactions that committed before the current transaction began. If there are one or more pending maintenance tasks for the materialized view/index 104 that originate from one or more update transactions whose effects the query is supposed to see, the query can be queued and the scheduler component 108 can schedule performance of the maintenance task(s) regardless of whether a CPU in a database system is “busy” (e.g., regardless of whether a workload of the CPU is above a threshold and/or executing high priority threads). The job constructor component 316 can construct job(s) for the maintenance task(s), and the maintenance component 106 can execute the jobs to update the materialized view/index 104. In an example, the maintenance job(s) executed by the maintenance component 106 can commit prior to resuming query execution. Accordingly, termination of the query does not trigger roll back of a committed maintenance job.

A slightly more complex case occurs when, within a same transaction, update statements are received that affect views referenced by subsequent queries. In this case, the queries are supposed to see all changes made by prior update statements within the transaction, and thus the materialized view/index 104 should be updated. However, such in-transaction changes to the materialized view/index should not be made permanent because the transaction may abort. Under snapshot isolation, this special case can be handled in the following manner: first, it can be determined that execution of a query plan that uses the materialized view/index 104 is about to begin. The maintenance component 106 may update the materialized view/index 104 as described above to bring the materialized view/index 104 up-to-date as of the beginning of the transaction. This part of maintenance can be done in separate transactions so that if the current transaction fails, the effects of the maintenance jobs will not be rolled back. The query monitor component 318 can ascertain whether the current transaction has updated any base table that is referenced by the materialized view/index 104. If the current transaction has updated a base table referenced by the materialized view/index 104, the maintenance component 106 can maintain the materialized view/index 104 by applying updates from this transaction to the materialized view/index 104. This part of maintenance may be executed in the current transaction so if the transaction later fails, all effects of the transaction on the view will be automatically rolled back.

In another example, the query monitor component 318 can determine that a query uses a materialized view/index with a pending maintenance task, and may also determine that the query does not use rows in the materialized view/index that are subject to maintenance. In this case, maintenance of the materialized view/index may be delayed until a query uses a portion of the materialized view/index that needs to be updated. For instance, the query monitor component 318 can project the query predicate onto each base table and scan corresponding delta tables with the projected predicate. If the scans return no tuples, the view/index content accessed by the query is not affected by pending updates.

When the maintenance component 106 completes execution of a maintenance job, the maintenance component 106 can remove completed maintenance tasks from the hash table 304, the update transaction list 310, and the second hash table 312. Further, the maintenance component 106 may release any row versions in the version store 206 and delta rows in the delta table 210 that are no longer required by remaining tasks. Additionally, the maintenance component 106 can remove the completed task from the pending task table 212. If the materialized view/index 104 is dropped, the maintenance component 106 can remove all pending tasks for the materialized view/index 104 from the hash table 304, the update transaction list 310, and the second hash table 312.

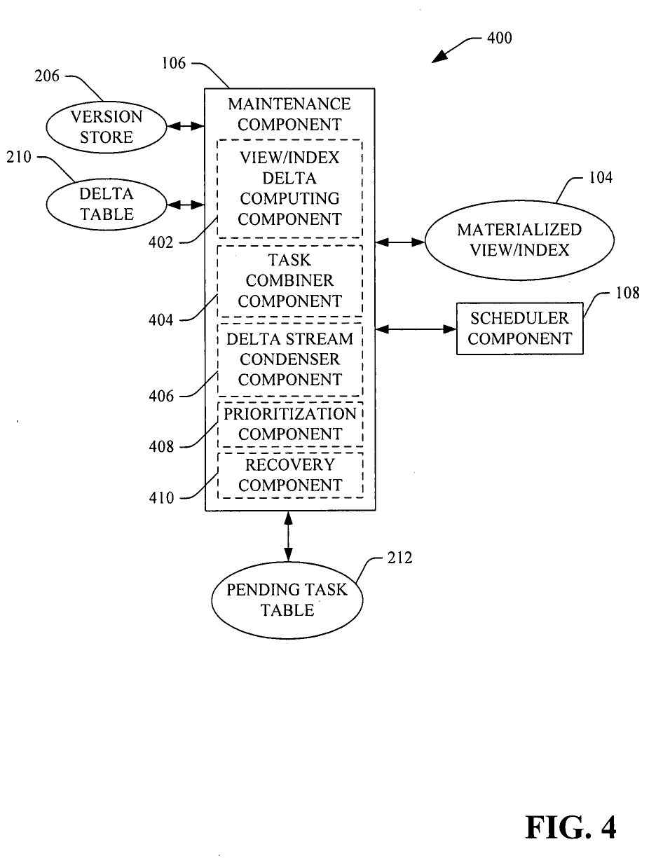

Now referring to FIG. 4, an example system 400 that can perform one or more maintenance tasks on the materialized view/index 104 is illustrated. The system 400 includes the maintenance component 106, which can access the version store 206 and the delta table 210 when performing a maintenance task on the materialized view/index 104. More specifically, the maintenance component 106 may use the TXSN of a transaction that causes the maintenance task and may also use the STMTSN of the statement that causes the maintenance task, if necessary, when performing the maintenance task.

The maintenance component 106 includes a view/index delta computing component 402 that can compute a view/index delta stream from the delta table 210 that is to be applied to the materialized view/index 104 with respect to a particular maintenance task. Prior to describing computation of a view/index delta stream for a maintenance task, however, normalization of delta streams is described.

A transaction T may include a series of update statements that update tables X and Y, where ΔXⁱ, i=1, . . . , n denotes the split delta stream produced by the ith statement updating table X, and ΔYⁱ, i=1, . . . , m denotes the split delta stream produced by the ith statement updating table Y. The update statements in the transaction T can be processed in some order when the transaction T executes, producing the delta streams in the same order. For instance, the delta streams may be produced in the order of ΔX¹, ΔY¹, ΔX², ΔY², etc. The states of X and Y when T begins to execute may be denoted as X₀ and Y₀, respectively, while the states of X and Y after T executes may be denoted as X_{F} and Y^{F}. If the delta streams are applied to states X₀ and Y₀, respectively, in the given order, the tables will be in the states X_{F} and Y_{F}. If the delta streams are re-ordered such that the X deltas occur first followed by the Y deltas (ΔX¹, . . . ΔXⁿ, ΔY¹, . . . ΔY^{m}) and then are applied to the states X₀ and Y₀, respectively, the tables will also end up in the states X_{F} and Y_{F}. The ordering among deltas for table X and for table Y and the ordering of records within each delta stream are not changed.

The X and Y deltas may then be concatenated, such that ΔX=ΔX¹, ΔX², . . . ΔXⁿ and ΔY=ΔY¹, ΔY², . . . ΔY^{m}. When performing concatenation, the delta rows from ΔX¹ should come before the delta rows from ΔX², and so on, which can be accomplished by sorting the delta rows in ascending order using TXSN and STMTSN of the update transaction and statements, respectively. The result of concatenation in this example is as if there had been two large update statements, producing delta streams ΔX and ΔY, respectively. If ΔX is applied to X₀ and ΔY is applied to Y₀, the tables will be in the final states X_{F} and Y_{F}. Accordingly, as can be discerned from the above examples, any sequence of delta streams can be normalized to an equivalent sequence of delta streams consisting of one delta stream for each affected table. Also, while the view/index delta computing component 402 is described as using normalized (concatenated) delta streams when computing view/index delta streams, it is to be understood that any suitable sequence of delta streams may be used by the view/index delta computing component 402.

To facilitate describing computation of a view/index delta for the materialized view/index 104 (to be used in connection with a maintenance task), a general case is considered where a maintenance task represents a transaction with multiple update statements that modify m of n base tables that are referenced by the materialized view/index 104. For instance, tables R₁, . . . Rₘ may be updated, wherein the materialized view/index 104 references these tables. Each update statement can update a single table, but different update statements may update a same table or different tables. In the case of maintaining an index, both m and n may be equal to “1”.

ΔR₁, ΔR₂, . . . , ΔRₘ, may be used in connection with maintaining the materialized view/index 104, where ΔR₁ is the concatenation of the split delta streams from statements updating table Rᵢ (as described above). Rᵢ′ can denote the state of table R at the end of the transaction, after applying ΔRᵢ to Rᵢ. As alluded to above, ΔRᵢ may be retrieved from the delta table 210 with appropriate selection predicates on TXSN. The version of Rᵢ before applying ΔRᵢ thereto (before version) and Rᵢ′ (after version) are also available by way of the version store 206 (or other suitable repository). Using the normalized delta streams, the view delta (ΔV) for the materialized view/index 104 can be computed by the view/index delta computing component 402 as:

ΔV=ΔR₁ [symbol] R₂ [symbol] . . . [symbol] Rₙ [symbol] {1}+R₁′ [symbol] ΔR₂ [symbol] R₃ [symbol] . . . [symbol] Rₙ [symbol] {2}+ . . . +R₁′ [symbol] . . . [symbol] Rₘ₋₁′ [symbol] ΔRₘ [symbol] . . . [symbol] Rₙ [symbol] {m}. (1)

The last join with a constant in each term will be explained further below. This expression can be used for both full and partial maintenance tasks.

The m base table deltas are applied one by one, in m steps. The view/index delta computing component 402 can compute the view/index delta for the materialized view/index 104 as if the transaction had proceeded as follows: first, all updates to base table R₁ are performed, producing the delta stream ΔR₁, and bringing the table to state R₁′. The first term in expression (1) can be used to compute the view/index delta that incorporates the effects of ΔR₁ into the materialized view/index 104. Next, all updates to base table R₂ can be performed, producing ΔR₂, and the table R₂ can be brought to state R₂′. The second term in expression (1) can be used to compute the view/index delta that incorporates the effects of ΔR₂ into the materialized view/index 104. This pattern may continue with one term for each updated base table until the m deltas are covered.

The final computed ΔV is the concatenation of the deltas from the m steps. A step sequence number (SSN) (or a similar sequencing device) is added to each row in ΔV by the last join in each term. Accordingly, all rows in ΔV generated by the ith term of expression (1) can have SSN=i. For instance, the combination of SSN, TXSN, and STMTSN defines the order in which to apply the delta rows to the materialized view/index 104. For example, all delta rows from the first term of expression (1) can be applied, and then all delta rows from the second term of expression (1) can be applied, etc. For each term, the delta rows are applied in statement sequence order, which is the order of the original update statements.

As noted above, expression (1) may be used not only for full maintenance tasks but also for partial maintenance tasks. To use expression (1) with partial maintenance tasks, adjustments can be made due to a prefix of deltas of base tables having already been applied to the materialized view/index 104. The statement sequence number (SSN) of the first unprocessed statement may be included in the maintenance task and can be denoted by Task_{STMTSN}. The before version of a base table used to compute ΔV may be the version at the beginning of statement Task_{STMTSN}. The normalized delta stream for the base tables can include deltas generated by statement Task_{STMTSN} or later. The view/index delta computing component 402 can retrieve an appropriate delta from the delta table 210 by using a selection predicate that specifies the TXSN as well as a lower bound on the STMTSN.

In summary, the view/index delta computing component 402 may compute a term of expression (1) for each updated table and concatenate the results. When computing the term that includes ΔRᵢ, the view/index delta computing component 402 can replace ΔRᵢ with a selection in the delta table corresponding to the base table. When reading other base tables, version hints may be applied to table read operators, instructing the version store 206 to return the appropriate version of each row. Additionally, the view/index delta computing component 402 can tag all changes applied to the materialized view/index 104 with the TXSN of the original transaction, the net effect being that the materialized view/index 104 appears to have been maintained by the original transaction.

The maintenance component 106 may optionally include a task combiner component 404 that combines maintenance tasks to enable more efficient updating of one or more materialized views/indexes. The task combiner component 404 may take into consideration gains in efficiency, additional time required to perform a combined task when compared to time required to perform tasks individually, urgency of maintenance tasks, and several other factors when determining which maintenance tasks to combine and/or whether to combine maintenance tasks. While the discussion below relates to combination of full maintenance tasks, it is to be understood that the task combiner component 404 can also combine partial maintenance tasks. An example is provided herein to describe functionality of the task combiner component 404.

The pending task table 212 may include a plurality of maintenance tasks to be performed by the maintenance component 106. For instance, the pending task table 212 may include l pending maintenance tasks for the materialized view/index 104 that were generated by transactions T₁, . . . , T₁, (in commit order) that update a set of base tables B₁, . . . , B₁, respectively. These transactions can be treated as a single transaction T₀. In more detail, Tₑ may have a smallest TXSN (e.g., Tₑ begins the earliest). The transaction T₀, then, starts at Tₑ(TXSN), ends at T₁(CSN) and updates the set of base tables B₁∪ . . . ∪B₁.

The view/index delta computing component 402 (using expression (1), for example) may then be applied to the transaction T₀. For instance, if Rᵢ is one of the base tables updated by the transactions T₁, . . . , T₁, then ΔRᵢ is the concatenation of the R deltas from these transactions (in commit order). The before version of a table is now the version before transaction Tₑ and the after-version includes the updates from all l participating transactions. Because the l transactions are treated as a single transaction, two versions of base tables Rᵢ, . . . , Rₘ plus their delta changes can be used by the view/index delta computing component 402. Similar to a single task, the combination of SSN, TXSN, and STMTSN may define the order in which to apply delta rows to the materialized view/index 104.

It is to be understood that maintenance tasks for a materialized view/index may not always be combinable because intermediate versions of the view/index may be lost. By combining tasks from the update transactions T₁, . . . , T₁, the updates applied to the materialized view/index 104 will be tagged with the TXSN of Tₑ such that all changes appear to be made by transaction Tₑ and the materialized view/index 104 is brought to the state produced by T₁. When a new version of a row is created, the old version will be kept if it may be read by an active transaction. If, at the point that the maintenance component 106 is to perform maintenance on the materialized view/index 104, there are no active transactions or other pending maintenance tasks that may require an intermediate version of the materialized view/index 104, the l tasks may be combined.

To further improve efficiency with respect to maintaining the materialized view/index 104, the maintenance component 106 may include a delta stream condenser component 406. For instance, multiple update transactions may affect a same subset of rows in a base table that is referenced by the materialized view/index 104. However, intermediate states are not necessary to maintain the materialized view/index 104—rather, an initial status of the base table rows and an end status of the base table rows is what is needed to perform a maintenance task. The delta stream condenser component 406 can condense view delta streams by removing intermediate base table states.

With more detail, as described above, a maintenance task may include delta streams from multiple update statements. Two or more update statements that update a same base table may affect the same base table row, and if so, will also affect the same row in the materialized view/index 104. Furthermore, updates that affect different rows in different base tables may end up affecting the same row in the materialized view/index 104. Accordingly, more than two rows with the same index keys may exist in a final computed view/index delta stream. When multiple maintenance tasks are combined, this situation becomes more prevalent. As noted above, the view/index delta row update order is crucial to achieve a correct result. It is not efficient, however, to apply such changes to a row of the materialized view/index 104 one by one.

The delta stream condenser component 406 can use a sorted view delta stream that may be sorted on unique clustering keys of the materialized view/index 104 plus an update order, which is the combination of SSN, TXSN, STMTSN, and the column that indicates an action. Sorting in this manner causes changes to a same row of the materialized view/index 104 to be grouped together in a correct update order. The action column may be used to order deletion of a row (if any) before an insertion originating from a same statement. The view stream condenser component 406 receives the sorted delta stream and produces a condensed delta stream by, in essence, discarding intermediate changes to rows.

For each group of rows with the same values of the unique clustering key, the delta stream condenser component 406 can output at most one row for a “Full Condense” or two rows for a “Partial Condense.” The output may depend on the first and last row of the view delta and can be summarized in Table 1 below:

TABLE 1

| | | First Row in the Group | |
|---|---|---|---|
| | | Insert | Delete |
| Last Row | Insert | Output Last Row | Full Condense: |
| in the Group | | | Output an Update Row |
| | | | Partial Condense: |
| | | | Output First and Last Row |
| | Delete | Output Nothing | Output Last Row |

The delta stream condenser component 406 may also be used to limit redundant computation caused by multiple updates to a same base table row. For example, the materialized view/index 104 may be a join of tables R and S (V=R [symbol] S). When combining multiple updates to the same base table R, if all updates change only one row, intermediate versions of that row may not be necessary to maintain the materialized view/index 104. Rather, the maintenance task may only use first and last delta rows, join them with table S, and apply the changes to the materialized view/index 104. Using the delta stream condenser component 406 in such a case may reduce a number of tuples participating in the joins and may reduce a cost of computing the view/index delta significantly.

Additionally, as noted above, the delta stream condenser component 406 may partially condense a delta stream of R, which may be viewed as being all update statements in a step with an equivalent update process, which contains only one update statement that changes R from a before version directly to an after version. Thus, if the first row is a delete and the last row is an insert, the delta stream condenser component 406 may output two rows. Generally, the delta stream condenser component 406 can condense delta rows if the delta rows affect a same view/index row.

In an example, the delta stream condenser component 406 may act as an operator that can perform a full or partial condense, and may occur before or after ajoin, for instance. In another example, individual delta streams may be sorted based upon unique keys plus the TXSN, STMTSN, and action column and results may be subject to a partial condensing.

The system 400 additionally includes a prioritization component 408 that can produce indications of priorities for maintenance tasks in the pending task table 212. The scheduler component 108 then may schedule maintenance tasks based at least in part upon the indications generated by the prioritization component 408. For instance, the prioritization component 408 may assign priorities to views and/or indexes based upon an expectation of when a view and/or index will be used by a query (e.g., how soon and/or often the views and/or indexes are expected to be used by queries). Thus, for instance, maintenance tasks for particular views may be assigned higher priorities than maintenance tasks for other views. Additionally, the prioritization component 408 may generate an indication of priority as a function of age of a maintenance task. For instance, pending maintenance tasks consume space for storing delta streams and old row versions. Cleanup both in the version store 206 and delta tables (including the delta table 210) can proceed linearly, such that oldest data is released first. Thus, a single old maintenance task may prevent much data from being released.

Still further, the prioritization component 408 may provide an indication of priority for maintenance tasks based at least in part upon similarities between views that are in need of maintenance. If similar views are maintained at the same time, it is possible to exploit common sub-expressions and achieve better buffer pool efficiency.

The system 400 may also include a recovery component 410 that recovers maintenance tasks in the pending task table 212. For instance, the pending task table 212 may be a persistent task table. The recovery component 410, in the event of a system crash, can recover the pending task table 212 and determine what delta streams and versions are needed by the remaining tasks. Required parts of delta tables and the version store 206 may then be rebuilt from a database log.

While the maintenance component 106 has been described above as using delta tables and the version store 206 when performing maintenance tasks, it is to be understood that other approaches are contemplated and are intended to fall under the scope of the hereto-appended claims. For instance, base table deltas may be extracted from a recovery log, and these deltas may be used as described above. In another example, base table deltas may be recovered from the version store 206. Moreover, access to versions of base tables may be provided in various ways. For instance, a previous version of a base table may be reconstructed from a current version of the base table by undoing changes made by all transactions that occurred later than a target transaction. Furthermore, while the maintenance component 106 is described above as concatenating view deltas, split delta streams, and terms of expressions, it is to be understood that various other techniques may be employed to improve efficiency of materialized view/index maintenance. For example, optimization techniques may be employed to improve efficiency of materialized view/index maintenance in connection with aspects described herein.

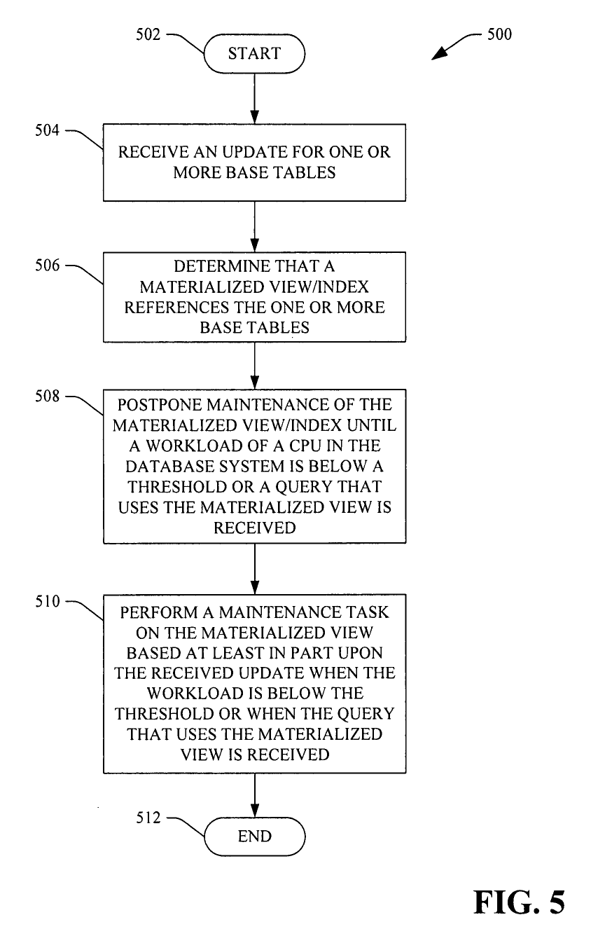

Now referring to FIG. 5, an example method 500 for performing maintenance on a materialized view and/or index is illustrated. The method 500 starts at 502, and at 504 an update to one or more base tables in a database system is received. At 506, a determination is made that a materialized view/index references the one or more updated base tables. At 508, maintenance of the materialized view/index is postponed until a workload of a CPU in the database system is below a threshold or until a query is received that uses the materialized view/index. At 510, a maintenance task is performed on the materialized view/index when the workload of the CPU in the database system is below the threshold or when the query that uses the materialized view/index is received. The method 500 then completes at 512.

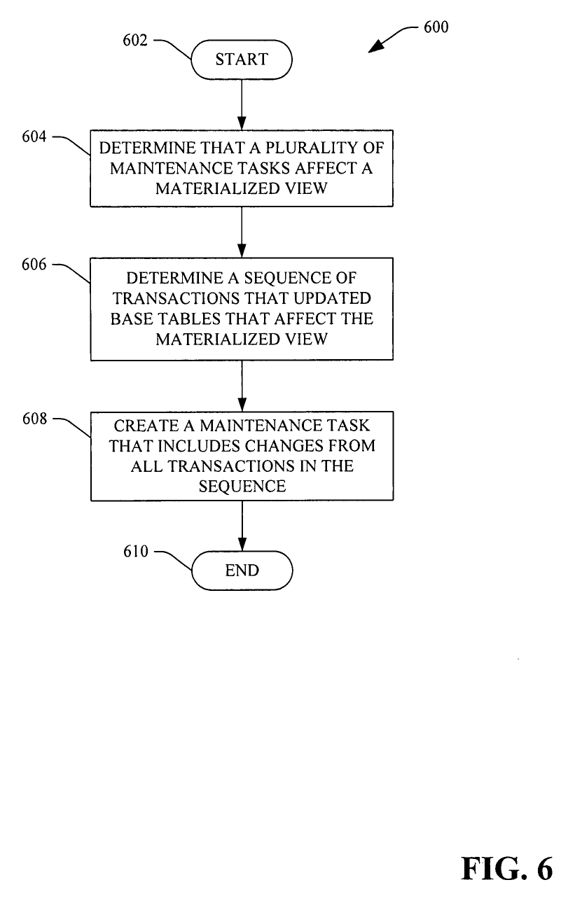

Now referring to FIG. 6, an example method 600 for combining maintenance tasks is illustrated. The method 600 starts at 602, and at 604 a determination is made that a plurality of maintenance tasks affects a single materialized view. At 606, a sequence of transactions that updated a base table that affect the materialized view/index is determined. At 608, a maintenance task is created that includes changes of all transactions in the sequence. Thus, the sequence of transactions is treated as a single transaction. The method 600 completes at 610.

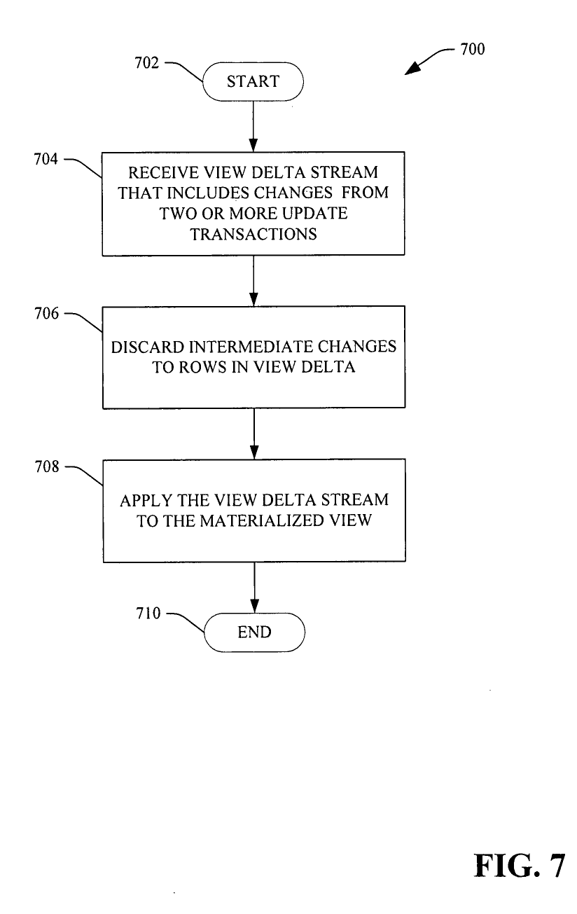

Turning now to FIG. 7, an example method 700 for condensing a delta stream is illustrated. The method 700 starts at 702, and at 704 a view delta stream that incorporates changes from two or more update transactions is received. At 706, intermediate updates to rows in the view are discarded. At 708, the view delta stream is applied to the materialized view/index. The method 700 then completes at 710. It is to be understood that condensing can be applied to input delta streams after concatenating delta streams from multiple transactions.

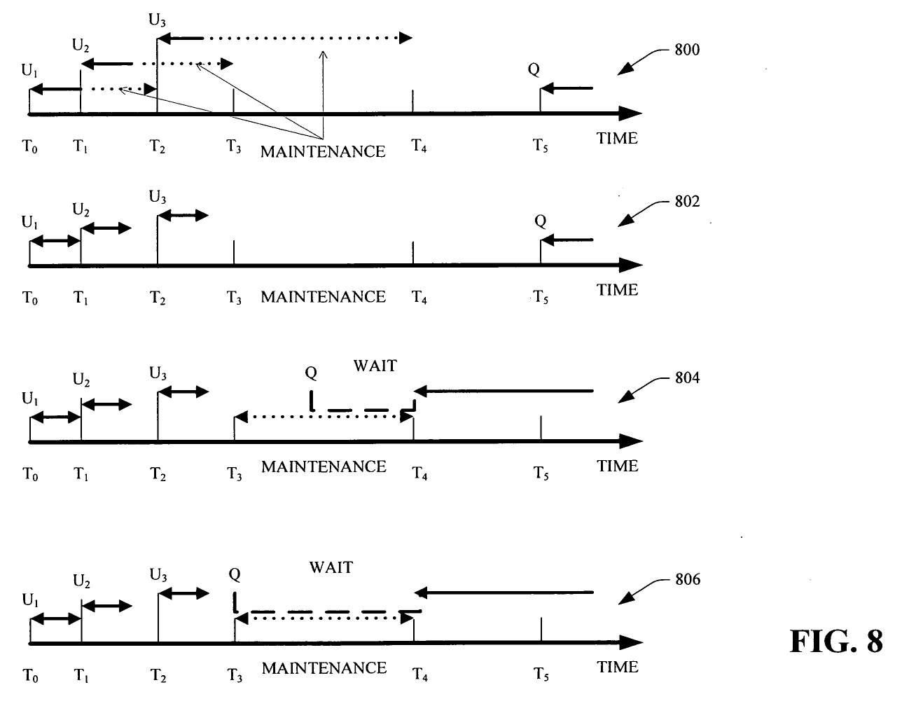

Referring now to FIG. 8, example timing diagrams 800, 802, 804, and 806 are provided to aid in describing materialized view/index maintenance in accordance with the various aspects described herein. The timing diagram 800 illustrates a first example update U₁ that begins at time T₀, updates a base table from time T₀ to T₁, maintains a view/index from time T₁ to T₂ and finally commits at time T₂. A second example update U₂ begins at time T₁, updates the same base table, maintains the same view/index, and commits at time T₃. A third example update U₃ begins at time T₂ and commits at time T₄. An example query Q arrives at time T₅ and begins executing immediately. Each of the example updates is an update to a base table that affects a materialized view/index. In conventional systems, as shown in timing diagram 800, maintenance would be performed as part of the update transaction, thereby extending the duration of the update transaction. In contrast, as shown in the diagram 802, applying the techniques describe herein, maintenance of the materialized view/index can be performed between times T₃ and T₄ when, for instance, a workload of a CPU in a database system is below a threshold. Thus, updates commit after updating the base table while maintenance is delayed until T₃. Still referring to diagram 802, at time T₅, an example query that uses the materialized view/index is received. Since the materialized view/index has been updated, the query can execute without being queued.

The example timing diagram 804 illustrates a similar scenario, except that the example query is received when maintenance is being performed on the materialized view/index. In such an instance, the query waits until the materialized view is updated, and thereafter (at time T₄) the query can use the materialized view/index.

The example timing diagram 806 illustrates arrival of a query at time T₃ that uses the materialized view prior to maintenance of the materialized view/index beginning. In such a case, receipt of the query initiates maintenance of the materialized view/index. After the maintenance has been performed on the materialized view/index, the query may use such view/index and begins execution at time T₄.

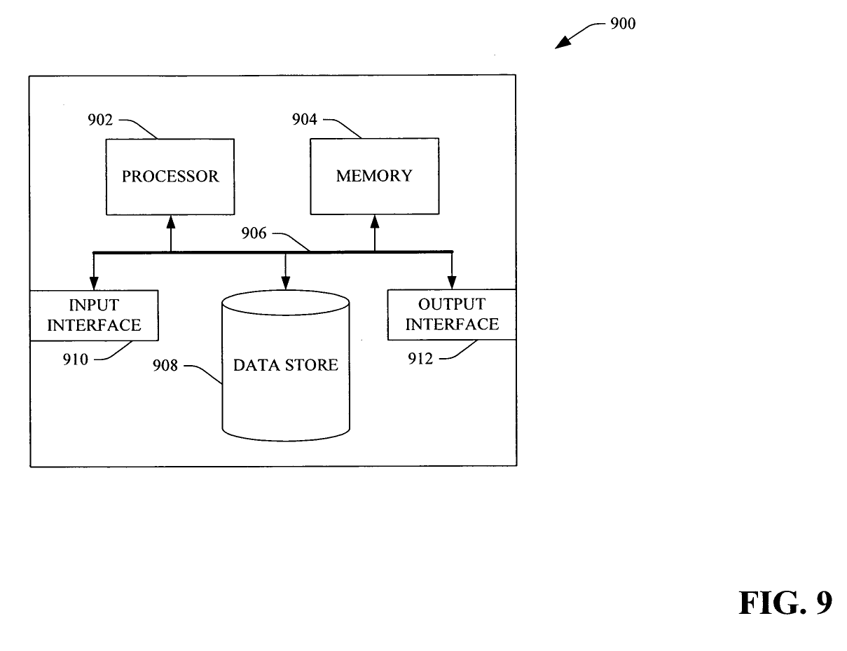

Now referring to FIG. 9, a high-level illustration of an example database system 900 that can be used in accordance with the systems and methods disclosed herein is illustrated. For instance, the database system 900 may be used in a data warehousing context. The database system 900 can be used in a conventional server setting, or may be employed in devices that are conventionally thought of as client devices, such as personal computers, personal digital assistants, and the like. The database system 900 includes at least one processor 902 that executes instructions that are stored in a memory 904. The instructions may be, for instance, instructions for implementing functionality described as being carried out by one or more components discussed above or instructions for implementing one or more of the methods described above. The processor 902 may access the memory by way of a system bus 906. In addition to storing executable instructions, the memory 904 may also store sorted lists of maintenance tasks, transaction lists, and the like.

The database system 900 additionally includes a data store 908 that is accessible by the processor by way of the system bus 906. The data store 908 may include one or more base tables, one or more materialized views or indexes that reference the base tables, one or more pending task tables, and other suitable data. The database system 900 also includes an input interface 910 that allows external devices to communicate with the database system 900. For instance, the input interface 910 may be used to receive an update to a base table or a query from a client device. The database system 900 also includes an output interface 912 that interfaces the database system 900 with one or more external devices. For example, the database system 900 may provide query results to a client by way of the output interface 912.

Additionally, while illustrated as a centralized system, it is to be understood that the database system 900 may be a distributed system. Thus, for instance, several devices may be in communication by way of a network connection and may collectively perform tasks described as being performed by the database system 900.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A materialized view or index maintenance system, comprising:
a task generator component that receives an indication that an update transaction has committed against a base table in a database system and generates a maintenance task for one or more of a materialized view or an index that is affected by the update transaction; and
a maintenance component that transparently performs the maintenance task when a workload of a CPU of the database system is below a threshold or when an indication is received that a query that uses the one or more of the materialized view or the index has been received.

2. The system of claim I, further comprising:
a prioritization component that provides indications of priority for a plurality of maintenance tasks that are to be performed by the maintenance component; and
a scheduler component that schedules the maintenance task for completion by the maintenance component based at least in part upon the indications of priority.

3. The system of claim 2, wherein an indication of priority is based at least in part upon an expectation of when the one or more of the materialized view or index will be used by a query.

4. The system of claim 1, wherein the materialized view references at least two base tables and the maintenance component uses a version of a first base table from a version store and a delta stream of a second base table from a delta table to complete the maintenance task.

5. The system of claim 1, further comprising a job constructor component that creates a maintenance job to be run as a background job.

6. The system of claim 1, further comprising:
a query monitor component that determines that a query has been issued that uses the one or more of the materialized view or index; and
a scheduler component that schedules the maintenance component to complete the maintenance task prior to execution of the query, wherein the query is executed after the maintenance task has been completed on the one or more of the materialized view or index.

7. The system of claim 1, further comprising a task combiner component that combines a plurality of maintenance tasks into the maintenance task that is completed with respect to the one or more of the materialized view or index.

8. The system of claim 7, wherein the task combiner component determines a sequence of update transactions that affect the one or more of the materialized view or index, treats the sequence of update transactions as a single update transaction, and generates a combined maintenance task that is completed with respect to the one or more of the materialized view or index.

9. The system of claim 1, further comprising a view delta computing component that computes a view/index delta for the one or more of the materialized view or index, wherein the maintenance task is a function of the view/index delta.

10. The system of claim 9, wherein the view delta computing component uses the following expression to compute a view/index delta for the materialized view or index:
ΔV=ΔR₁ [symbol] R₂ [symbol] . . . [symbol] Rₙ [symbol] {1}+R₁′ [symbol] ΔR₂ [symbol] R₃ [symbol] . . . [symbol] Rₙ [symbol] {2}+ . . . +R₁′ [symbol] . . . [symbol] Rₘ₋₁′ [symbol] ΔRₘ [symbol] . . . [symbol] Rₙ [symbol] {m}. (1)
wherein ΔV is the view/index delta, R₁ through Rₙ are base tables referenced by the materialized view or index, R₁ through Rₘ are base tables that have been updated by one or more update transactions, ΔRᵢ is a concatenation of split delta streams from update statements that update table Rᵢ, and Rᵢ′ denotes a state of table Rᵢ after ΔRᵢ has been applied thereto, where i, m, and n are positive integers with i≦m≦n.

11. The system of claim 10, further comprising a delta stream condenser component that accesses the view/index delta, receives a sorted view/index delta stream, and produces a condensed view/index delta stream by discarding intermediate changes to a row of the materialized view or index.

12. The system of claim 10, further comprising a delta stream condenser component that accesses a delta table for base table Rᵢ, receives a sorted delta stream for the base table Rᵢ, and produces a condensed delta stream by discarding intermediate changes to a row of the base table Rᵢ, wherein the condensed delta stream is used to compute the delta view or index.

13. The system of claim 1, further comprising a recovery component that recovers a pending maintenance task list if the database system crashes.

14. A method for maintaining one or more of a materialized view or index in a database system, comprising:
receiving an update for a base table that is referenced by the one or more of the materialized view or index;
postponing maintenance of the one or more of the materialized view or index until a workload of a CPU in the database system is below a pre-defined threshold or a query that uses the one or more of the materialized view or index is received; and
performing a maintenance task that is based at least in part upon the received update on the one or more of the materialized view or index when the workload is below the pre-defined threshold or when the query that uses the one or more of the materialized view or index is received.

15. The method of claim 14, further comprising selecting the maintenance task from a plurality of pending maintenance tasks.

16. The method of claim 14, further comprising combining two or more maintenance tasks to create the maintenance task.

17. The method of claim 14, further comprising scheduling the maintenance task to run as a background maintenance job.

18. The method of claim 14, further comprising:
assigning indications of priority to a plurality of maintenance tasks; and
completing the maintenance task at a time that is based at least in part upon the assigned indications of priority.

19. The method of claim 14, further comprising accessing a version store and at least one delta table when generating the maintenance task.

20. An apparatus, comprising:
a memory comprising instructions for performing the following acts:
receiving a schedule for performing a maintenance task for one or more of a materialized view or index, wherein the schedule indicates when a workload of a CPU in a database system that includes the one or more of the materialized view or index is below a threshold; and
completing the maintenance task at an earlier of a time indicated in the schedule or when a query that uses the one or more of the materialized view or index is received; and
a processor that is configured to execute the instructions.
